(19) United States
(12) Patent Application Publication
(10) Pub. No.: US 2026/0117146 A1
(43) Pub. Date: Apr. 30, 2026

(54) Clog Release Compositions and Methods

(71) Applicant: PurposeBuilt Brands, Inc., Gurnee, IL (US)

(72) Inventors: Sun Yoon, Wheeling, IL (US); Steve Richmond, Kenosha, WI (US); Sylwia Aldrin, Gurnee, IL (US); Brian Holland, Deerfield, IL (US)

(21) Appl. No.: 19/371,502

(22) Filed: Oct. 28, 2025

Related U.S. Application Data
(60) Provisional application No. 63/713,408, filed on Oct. 29, 2024.

(51) Int. Cl. C11D 3/37; C11D 3/12; C11D 3/24; C11D 3/34; C11D 3/386; C11D 3/395; C11D 17/00

(52) U.S. Cl. CPC C11D 3/373; C11D 3/12; C11D 3/245; C11D 3/3436; C11D 3/386; C11D 3/395; C11D 17/003; C11D 2111/16

(57) ABSTRACT

Some aspects of the disclosure relate to compositions for releasing a material clog. In some examples, the compositions include one or more release agents, such as a silicone material, one or more thickening agents, and one or more complexing agents. In certain aspects, the disclosure relates to non-hazardous compositions for releasing a material clog, for example compositions with limited amounts of or no amounts of caustic and/or alkaline material. In other aspects, the disclosure relates to methods for releasing a material clog by contacting a release composition and a clog for a contact time period, and/or pretreating plumbing component surfaces or plumbing component standing water with a release composition before formation and/or deposition of a clog.

### RELATED APPLICATIONS

This application claims the benefit of and priority to U.S. Provisional Patent Application No. 63/713,408 entitled Clog Release Compositions and Methods and filed on Oct. 29, 2024, which is expressly incorporated herein by reference in its entirety for any and all non-limiting purposes.

### TECHNICAL FIELD

In some aspects, this disclosure relates to compositions for releasing a material clog (e.g. a clog of feces and/or fibrous material like toilet paper), for example a composition with one or more release agents such as a silicone material. The composition may also include one or more thickening agents and/or one or more complexing agents. In certain aspects, the disclosure relates to non-hazardous compositions for releasing a material clog. In another aspect, the disclosure relates to methods for releasing a material clog comprising contacting the clog with one or more release agents and maintaining the contact for a contact period. In yet another aspect, the disclosure relates to methods of pretreating one or more plumbing component surfaces prior to deposition of a material clog, comprising contacting the one or more plumbing component surfaces and/or a liquid already in contact with the surfaces, such as water, with a release composition.

### SUMMARY

This Summary provides an introduction to some general concepts relating to this disclosure in a simplified form, where the general concepts are further described below in the Detailed Description. This Summary is not intended to identify key features or essential features of the disclosure.

In some aspects, this disclosure relates to, inter alia, compositions for releasing a material clog. In some examples, the composition may include one or more release agents, one or more thickening agents, and one or more complexing agents.

In some examples, the composition may include one or more release agents, where the one or more release agents comprise at least one silicone material, one or more thickening agents, one or more complexing agents, and one or more diluents, where the one or more release agents are present in an amount of 25% or less of the composition, by weight, where the one or more diluents are present in an amount totaling between 10-99% of the composition, by weight, where the one or more thickening agents are present in an amount totaling between about 0-20%, and where the one or more complexing agents are present in an amount totaling about between about 0-20% of the composition, by weight.

In certain examples, the one or more release agents may include or consist of at least one silicone material, such as a silicone emulsion. In some examples, the one or more release agents may be present in an amount totaling about 25% or less of the composition, by weight, about 15% or less of the composition, about 10% or less, about 5% or less, about 2.5% or less of the composition.

In some examples, the composition further includes one or more diluents such as water, the one or more diluents may be present in an amount totaling between about 10-99% of the composition, by weight, or about 50-99% of the composition, or about 80-95% of the composition, by weight, or about 90-99% of the composition, by weight. In some examples, the one or more diluents may be present in an amount totaling at least about 40% of the composition, by weight, or at least about 50% of the composition, or at least about 70% of the composition, or at least about 80% of the composition, or at least about 90% of the composition. In some examples, the composition is aqueous.

In certain embodiments, the composition is non-hazardous. In various examples, the composition does not include any caustic material, and/or does not include any bleach material. In some examples, the composition includes one or more caustic materials present in an amount totaling about 75% or less of the composition, by weight, or about 50% or less of the composition, or about 25% or less of the composition, or about 10% or less of the composition, or about 5% or less of the composition, or about 2% or less of the composition, or about 1% or less of the composition. In certain examples, the composition includes one or more bleach materials, the one or more bleach materials present in an amount totaling about 75% or less of the composition, by weight, or about 50% or less of the composition, or about 25% or less of the composition, or about 10% or less of the composition, or about 5% or less of the composition, or about 2% or less of the composition, or about 1% or less of the composition. In some example, the composition does not include any alkaline material.

In some examples, the one or more release agents include one or more liquid release agents, for example at least one silicone material, at least one mineral oil, at least one plant-based oil, at least one ether material, at least one ester material, at least one polyolefin material, at least one fluorocarbon material, or mixtures thereof. In certain embodiments, the one or more release agents include one or more solid release agents, for example graphite, at least one fluorocarbon material, at least one disulphide material, or mixtures thereof.

In certain examples, the composition may further include one or more surfactants, hydrotropes, preservatives, salts, bacterial spore materials, neutralizing materials, or mixtures thereof. In some embodiments, the composition may further include one or more enzyme materials, where the one or more enzyme materials are capable of acting to breakdown the material clog.

In some examples of the composition, the one or more release agents include one or more polydimethylsilicone materials, one or more alkyl-derivatized silicone materials such as C2-C18 alkyl-derivatized silicones, one or more dimethiconol materials, one or more polyether-modified silicone materials, one or more silicone materials comprising one or more amino groups and/or quaternized ammonium groups, and mixtures thereof. In certain examples of the composition, the one or more release agents include at least one silicone material with a viscosity of about 1-10 million mPas, about 1-5 million mPas, about 0.1-1 million mPas, about 5-10 million mPas, about 7-12 million mPas, or about 10-12 million mPas.

In various examples of the composition, the one or more thickening agents include one or more gum materials such as xanthan gum, one or more polymer materials such as a synthetic polymer material like a acrylate homopolymer and/or a polymer comprising an acrylate copolymer, and derivatives of such polymer materials, one or more acrylic acid-based polymer materials, one or more non-ionic polymer materials, one or more surfactant materials such as an amphoteric, anionic, and non-ionic surfactant material, and one or more swelling or non-swelling clay materials such as a smectite clay material and/or a montmorillonite material. In some examples, the one or more thickening agents are present in an amount totaling about between about 0-20% of the composition, by weight, or about 0-10% of the composition, by weight, or about 0.1-10% of the composition, or about 0.01-5% of the composition, or about 0.5-5% of the composition, by weight, or about 0.1-5% of the composition, by weight, or about 0.1-3% of the composition, by weight, or about 0.1-1% of the composition, by weight, or about 1-3% of the composition, by weight.

In certain examples of the composition, the one or more complexing agents include a sodium citrate material, one or more phosphate materials, one or more phosphonate materials, one or more citrate materials, one or more iminodisuccinates, glucoheptonate, methylglycine diacetic acid, or one or more salts of EDTA, GLDA, DTPA, HEDTA, EDG, and PDTA. In various examples of the composition, the one or more complexing agents are present in an amount totaling about between about 0-20% of the composition, by weight, or about 0-10% of the composition, or about 0.0.1-10% of the composition, or about 0.01-5% of the composition, by weight, or about 0.1-5% of the composition, by weight, or about 0.1-3% of the composition, or about 1-3% of the composition, by weight.

In certain examples of the composition, the one or more complexing agents are present in an amount totaling about between about 0-30% of the composition, by weight, or about 0-20% of the composition, or about 0.1-20% of the composition, or about 0.01-10% of the composition, or about 1-7% of the composition, or about 5-10% of the composition, or about 1-25% of the composition, by weight.

In some aspects of the disclosure, the composition is a liquid material, such as being an aqueous liquid that, for example, may be added to a plumbing surface for pretreatment and/or applied to a clogged plumbing fixture (e.g. a toilet and/or drain and/or pipe). In some aspects of the disclosure, the composition is a gel material or a solid material, such as a tablet or powder.

In another aspect of the disclosure, a non-hazardous composition for releasing a material clog is provided, the composition including a release agent that contains at least a silicone material.

In yet another aspect of the disclosure, methods for releasing a material clog are disclosed. Example methods may include contacting the clog with one or more release agents including a silicone material and maintaining the contact of the one or more release agents and the clog for a contact period. In some examples, no mechanical action beyond flowing water (e.g. a toilet flush) is used after the contact period to release the clog. In some examples, the contact period is 30 minutes or more. In certain embodiments of the method, the clog is contacted with any of the compositions described herein. In some example, the material clog includes or consists of one or more biological materials, one or more fibrous materials, one or more cellulosic materials, or combinations thereof. In some examples of the method, the method further includes pretreating one or more plumbing component surfaces prior to deposition of the material clog with the one or more release agents.

In certain aspects of the disclosure, methods of pretreatment for one or more plumbing component surfaces prior to deposition of a material clog are disclosed, the methods including contacting the one or more plumbing component surfaces with any of the compositions described herein, either by direct application, addition to a liquid already in contact with the surfaces such as water, or a combination thereof.

These and other features, advantages, and objects of the present disclosure will be further understood and appreciated by those skilled in the art by reference to the following specification and claims.

### DETAILED DESCRIPTION

The examples, materials and methods of described herein provide, inter alia, compositions for releasing a material clog (e.g. a clog of feces and/or fibrous material like toilet paper). In certain aspects, the disclosure relates to non-hazardous compositions for releasing a material clog. In another aspect, the disclosure relates to methods for releasing a material clog comprising contacting the clog with one or more release agents and maintaining the contact for a contact period. In yet another aspect, the disclosure relates to methods of pretreating one or more plumbing component surfaces prior to deposition of a material clog, comprising contacting the one or more plumbing component surfaces and/or a liquid already in contact with the surfaces such as water with a release composition. These and other aspects, features and advantages of the disclosure or of certain embodiments of the disclosure will be further understood by those skilled in the art from the following description of example embodiments. In the following description of various examples, reference is made to the accompanying drawings, which form a part hereof. It is to be understood that other modifications may be made from the specifically described methods and systems without departing from the scope of the present disclosure.

It is also to be understood that the specific materials, systems, devices and processes described in the following specification, are simply example embodiments. Hence, specific numerical values, dimensions and other characteristics relating to the embodiments disclosed herein are not to be considered as limiting.

Ranges: throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. It is understood that any and all whole or partial integers between any ranges set forth herein are included herein.

Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those skilled in this art without departing from the spirit and scope of the disclosure.

In some aspects, this disclosure relates to processes of, inter alia, compositions for releasing a material clog. Example compositions may facilitate and/or initiate movement of a clog, for example through piping attached to the toilet. The compositions may be dosed into a clogged plumbing component such as a toilet, or piping that is directly and/or indirectly connected to a toilet. The composition may be added to treat plumbing surface(s) or standing water as a preemptive measure, or may be dosed when the system is clogged, or both. The composition may remain in contact with a clog until it releases, or for a contact time before additional clearance efforts, such as running additional water, flushing, rodding, and/or plunging. The composition may act to reduce friction and/or lubricate the piping, the clog, or both, and may facilitate its movement and eventual release through a pipe.

In some examples, the composition may include one or more release agents, one or more thickening agents, and one or more complexing agents. In certain examples, the one or more release agents may include or consist of at least one silicone material, such as a silicone emulsion. The silicone material or materials may include a silicone-based polymer, such as polydimethylsiloxane (PDMS). In certain examples, other components, e.g., one or more surfactants and/or one or more hydrotropes, may be used to further facilitate the release agent (e.g. silicone) to surfaces of the piping and/or individual clog particulates to help speed up displacement of a clog. In some examples, unlike highly active toilet clog removers with hazardous ingredients, the compositions with release agents may need a contact time, for example up to fifteen minutes or one hour, to work, but are effective without any associate dangers to user health or integrity of plumbing components that can result from hazardous materials.

In some examples, the one or more release agents may be present in an amount totaling about 25% or less of the composition, by weight, about 15% or less of the composition, about 10% or less, about 5% or less, about 4% or less, about 3% or less, about 2.5% or less, about 2% or less, about 1.5% or less, or about 1% of or less of the composition. In some examples, a release agent (or a total amount of release agents) may be present in an amount of about 0.01-25%, 0.1-15%, or 1-10%, by weight, of the composition.

In some examples of the composition, the one or more release agents include one or more polydimethylsilicone materials (for example polydimethylsilicone materials ranging in viscosity from about 10 to about 1 million mPas), one or more alkyl-derivatized silicone materials such as C2-C18 alkyl-derivatized silicones, one or more dimethiconol materials, one or more polyether-modified silicone materials, one or more silicone materials comprising one or more amino groups and/or quaternized ammonium groups, and mixtures thereof. In certain examples of the composition, the one or more release agents include at least one silicone material with a viscosity of about 1-10 million mPas, about 1-5 million mPas, about 0.1-1 million mPas, about 5-10 million mPas, about 7-12 million mPas, or about 10-12 million mPas. Silicone materials and/or release agent materials can be emulsified in-formula or be procured already emulsified, for example, from Momentive Performance Materials, Inc.

In certain examples, a silicone emulsion is used as a release agent material or as the only release agent material. In some examples, the emulsion may include about 1-15%, by weight, of surfactant(s). One or more surfactants may facilitate the silicone material, e.g. polydimethylsiloxane, stay suspended in water. In certain examples, the surfactant(s) are nonionic and/or anionic. In an example emulsion, polydimethylsiloxane is present in an amount of about 60-90%, by weight, of the release material emulsion. The silicone material may provide friction reduction/lubricity. In certain example emulsions of release material, a diluent (or diluents) such as water is present in an amount of about 10-60%, by weight. In various example emulsions of release material, one or more preservatives are present, e.g. a material that can limit or prevent decomposition by microbial growth and/or other undesirable chemical changes.

In some examples, the composition further includes one or more diluents, such as water. The one or more diluents may be present in an amount totaling between about 10-99% of the composition, by weight, or about 50-99% of the composition, or about 80-95% of the composition, by weight, or about 90-99% of the composition, by weight. In some examples, the one or more diluents may be present in an amount totaling at least about 40% of the composition, by weight, or at least about 50% of the composition, or at least about 70% of the composition, or at least about 80% of the composition, or at least about 90% of the composition. In some examples, the composition is aqueous.

In certain embodiments, the composition is non-hazardous. Thus, composition embodiments may be unlike many of the products out in the marketplace that contain bleach and/or caustic material and/or have high acid and/or alkalinity levels. Many clog removers, regardless of the fixture being added to, e.g., a toilet, shower, bathroom and kitchen sinks, utilize bleach and/or caustic and/or alkaline (e.g. high alkalinity) materials to help disintegrate a clog. Such materials present dangers to users or persons who otherwise come into contact with the materials, including serious eye damage and skin irritation, and can also damage (e.g. via corrosivity) to piping or other fixtures, especially when they are metal based materials. In contrast to the harsh and dangerous nature of such materials, example compositions of this disclosure allow prevention (e.g. through pre-treatment of toilet surfaces and/or standing toilet water) and/or release of clogs through a different mechanism. Example compositions may coat the piping and/or the particulates in the clog, reducing friction between the surfaces and providing lubricity so the clog can move through the piping, ultimately clearing it, or preventing stagnation and stoppage in the first place.

For the avoidance of doubt, in some examples, the composition does not include any caustic material, and/or does not include any bleach material. In certain embodiments, no bleach and/or caustic and/or alkaline materials are used. But in certain examples, some amount of bleach and/or caustic material(s) and/or alkaline material(s) and/or acidic material(s) may be used in connection with release material(s), although in some examples these harsher materials are present in small amounts only, especially compared to typical products currently in the marketplace. In some examples, the composition includes one or more caustic materials present in an amount totaling about 75% or less of the composition, by weight, or about 50% or less of the composition, or about 25% or less of the composition, or about 10% or less of the composition, or about 5% or less of the composition, or about 2% or less of the composition, or about 1% or less of the composition. In certain examples, the composition includes one or more bleach materials, the one or more bleach materials present in an amount totaling about 75% or less of the composition, by weight, or about 50% or less of the composition, or about 25% or less of the composition, or about 10% or less of the composition, or about 5% or less of the composition, or about 2% or less of the composition, or about 1% or less of the composition. In some example, the composition does not include any alkaline material. In some examples, the composition has a pH between about 5 and about 9, or about 6 and about 8, or about 6.5 and about 7.5. In some examples, the composition does not include any material with a pH below about 5 or above about 9, while in other examples, the composition only includes relatedly smaller amounts of such materials compared to more near neutral or neutral pH components, such that the overall pH is closer to neutral.

In some examples, the one or more release agents include one or more liquid release agents, for example at least one silicone material, at least one mineral oil, at least one plant-based oil (e.g. one or more vegetable oils such as soybean oil or linseed oil), at least one ether material, at least one ester material, at least one polyolefin material (such as hydrogenated polyolefin(s)), at least one fluorocarbon material, or mixtures thereof. In certain embodiments, the one or more release agents include one or more solid release agents, for example graphite, at least one fluorocarbon material (such as polytetrafluoroethylene), at least one disulphide material (such as a metal disulphide), or mixtures thereof.

In certain examples, the composition may further include one or more surfactants, hydrotropes, preservatives, salts, bacterial spore materials, neutralizing materials, or mixtures thereof. In some embodiments, the composition may further include one or more enzyme materials (e.g. in an amount of about 0.01-1% or 0.01-0.1%, or 0.01-1%, or 0.01-5%, of the composition, by weight), where the one or more enzyme materials are capable of acting to breakdown the material clog. In certain examples, the compositions may act on a clog via enzymes for non-harsh breakdown efforts that are enhanced by subsequent friction reduction. In certain examples, the compositions may have distinct formulations to be applied in sequence, e.g. one with breakdown components such as enzymes, and one with release agent(s), which can be added before, with, ad/or after the breakdown enzyme composition.

In various examples of the composition, the one or more thickening agents include one or more gum materials such as xanthan gum, one or more polymer materials such as a synthetic polymer material like a acrylate homopolymer and/or a polymer comprising an acrylate copolymer, and derivatives of such polymer materials, one or more acrylic acid-based polymer materials, one or more non-ionic polymer materials, one or more surfactant materials such as an amphoteric, anionic, and non-ionic surfactant material, and one or more swelling or non-swelling clay materials such as a smectite clay material and/or a montmorillonite material. In some examples, the one or more thickening agents are present in an amount totaling about between about 0-20% of the composition, by weight, or about 0-10% of the composition, by weight, or about 0.1-10% of the composition, or about 0.01-5% of the composition, or about 0.5-5% of the composition, by weight, or about 0.1-5% of the composition, by weight, or about 0.1-3% of the composition, by weight, or about 0.1-1% of the composition, by weight, or about 1-3% of the composition, by weight, or about 10% or less, or about 5% or less, or about 3% or less. An example thickening agent is FED-CS from Jungbunzlauer Inc. Other example thickening agents include polymer organic thickening agents such as acrylate homo- or copolymers and derivatives thereof. Additional example thickening agents include one or more acrylic acid-based polymers, one or more non-ionic polymers, one or more surfactants (which may be amphoteric, anionic, and non-ionic), and one or more swelling or non-swelling clay materials such as smectite clay or montmorillonite clay. In some examples, the one or more thickening agents (or any individual components of the agent(s)) may have a viscosity of about 0-5000 cp, about 50-3000 cp, or about 100-1000 cp, as measured at 25 degrees Celsius and using standard equipment/techniques for such substances.

In certain examples of the composition, the one or more complexing agents include a sodium citrate material, one or more phosphate materials, one or more phosphonate materials, one or more citrate materials, one or more iminodisuccinates, glucoheptonate, methylglycine diacetic acid, or one or more salts of EDTA, GLDA, DTPA, HEDTA, EDG, and PDTA. Example complexing agents may bind cations such as calcium and/or magnesium, e.g. to soften the water and/or enhance water quality. This may bolster the effectiveness of the release agent(s). Other example complexing agents include acetic acid materials, glucoheptonate, and methylglycinediacetic acid.

In certain examples of the composition, the one or more complexing agents are present in an amount totaling about between about 0-30% of the composition, by weight, or about 0-20% of the composition, or about 0.1-20% of the composition, or about 0.01-10% of the composition, or about 1-7% of the composition, or about 5-10% of the composition, or about 1-25% of the composition, by weight, or about 10% or less, about 5% or less, about 3% or less.

In another aspect of the disclosure, a non-hazardous composition for releasing a material clog is provided, the composition including a release agent that contains at least a silicone material. Example non-hazardous compositions may not include any caustic and/or alkaline materials, or may only include small amounts of such material(s).

In some examples, the composition includes one or more surfactants, e.g. in an amount of about 0-25%, about 0.1-15%, or about 1-10%, by weight. Example surfactants include nonionic surfactants such as alcohol ethoxylates, alkanolamides, alkylamines, alkyl polyglucosides, ethylene oxide and propylene oxide copolymers, anionic surfactants such as alcohol sulfates, alkanesulfonates, alkylbenzenesulfonates, alkyl ether sulfates, and olefinsulfonates, and/or amphoteric surfactants such as amine oxides, betaines, imidazolines, sulfobetaines, and/or sultaines, e.g. a material like Alkonat L 70.

In certain examples, the composition includes one or more hydrotropes, e.g. in an amount of about 0-5%, about 0.5-4%, or about 1-3%, by weight. Example hydrotropes include sodium xylenesulfonate and/or sodium cumenesulfonate. In some examples, the composition includes one or more preservatives, e.g. in an amount of about 0-1%, about 0.05-0.5%, or about 0.1-0.2%, by weight (for example a material like Acticide MBS). Example preservatives include benzoic acid, benzoic acid derivatives, phenols, quaternary ammonium, DMDM hydantoin, methylchloroisothiazolinone, methylisothiazolinone, octylisothiazolinone, iodopropynyl butylcarbamate, benzisothiazolinone, and/or quaternium 15.

In certain examples, the composition includes one or more salts, e.g. in an amount of about 0.1-5%, about 0.5-4%, or about 1-3%, by weight. Example salts include acetates, borates, bromides, carbonates, chlorides, citrates, hydroxides, iodides, nitrates, nitrites, phosphates, phosphonates, sulfates, sulfides, and/or sulfites, e.g. a material like Dissolvine GL-47-S.

In some examples, the composition includes one or more bacterial materials such as bacterial spores, e.g. with a count of about 1×10⁶⁻⁹ cfu/mL, about 5-10×10⁷ cfu/mL, or about 6-8×10⁷ cfu/mL. Example bacterial spores include Bacillus subtilis, Bacillus amyloliquefaciens, Bacillus licheniformis, Bacillus megaterium, and/or Bacillus pumilus. The one or more bacterial materials may be a liquid blend of spores. The one or more bacterial materials may be present in an amount totaling about 0.01-10% of the composition, by weight, about 0.5-7%, about 1-5.5%, about 4-5.5%, about 6-8%, about 0.01-0.1%, about 2-4%, or about 6% or less, or about 5% or less, or about 4% or less, or about 3% or less, or about 1% or more, or about 3% or more, or about 5% or more. In certain examples, the composition includes one or more neutralizers, e.g. for thickening, for example in an amount of about 0-2%, about 0.1-0.8%, or about 0.2-0.5%, by weight. Example neutralizers include monoethanolamine, diethanolamine, triethanolamine, monoisopropanolamine, diisopropanolamine, triisopropanolamine, morpholine, aminomethyl propanol), hydroxide material(s) (such as sodium hydroxide, potassium hydroxide, and/or ammonium hydroxide), and/or sodium chloride.

In some aspects of the disclosure, the composition is a liquid material, such as being an aqueous liquid that, for example, may be added to a plumbing surface for pretreatment and/or applied to a clogged plumbing fixture (e.g. a toilet and/or drain and/or pipe). The material may disperse and/or mix with ambient water to allow the materials to come into contact with a material clog and/or one or more plumbing surfaces. In some aspects of the disclosure, the composition is a gel material or a solid material, such as a tablet or powder. In some examples, a solid material like a tablet or powder may slowly dissolve over time, releasing the materials of the composition over an extended period, e.g. so they are solubilized and/or mixed and/or dispersed in ambient water to eventually come into contact with a material clog and/or one or more plumbing surfaces. For example, the solid material may be added as a tablet or other form to a toilet tank and dissolve/release components over time as the toilet is used, for example over about a day or more of use, about 3 days or more, about 5 days or more, about 7 days or more, about 10 days or more, about 20 days or more, about 30 days or more, about 50 days or more, about 75 days or more, or about 100 days or more, until a point is reached after these threshold values where the material is fully dissolved/released. In some examples, a solid material may dissolve/release components over time, e.g. from a toilet tank as the toilet is used and flushed, for example over about 10-30 days, about 15-50 days, about 30-60 days, about 20-45 days, about 50-100 days, about 1-10 days, about 1-30 days, about 10-20 days, or about 5-30 days. In some examples, a solid material may dissolve/release components over time and at least more than one day in total, e.g. from a toilet tank as the toilet is used and flushed, for example lasting at least one day and further acting to dissolve/release materials until about 5, 10, 15, 20, 25, 30, 45, 60, or 100 days.

In yet another aspect of the disclosure, methods for releasing a material clog are disclosed. Example methods may include contacting the clog with one or more release agents including a silicone material and maintaining the contact of the one or more release agents and the clog for a contact period. In some examples, no mechanical action beyond flowing water (e.g. a toilet flush) is used after the contact period to release the clog. In some examples, the contact period is about 30 minutes or more, about 5 minutes or more, about 10 minutes or more, about 15 minutes or more, about 45 minutes or more, or about 60 minutes or more. In some examples, the contact period is about 60 minutes or less, about 45 minutes or less, about 30 minutes or less, about 20 minutes or less, about 10 minutes or less, or about 1-10 minutes, about 5-20 minutes, about 15-30 minutes, about 30-60 minutes, or about 30-45 minutes.

In certain embodiments of the method, the clog is contacted with any of the compositions described herein and/or with components of the same. For example, about 10 grams of more of release composition may be added to a toilet bowl when a clog is present in the bowl and/or directly or indirectly coupled plumbing, or about 20 grams or more, or about 50 grams or more, or about 100 grams or more, or about 150 grams or more, or about 200 grams or more. In certain examples, the composition is added to the plumbing component and sits before an attempt to dislodge (e.g. with a toilet flush and/or plunging and/or rodding). This can allow contact time, such that the composition may come into contact with the clog to reduce friction between the surface of the clog and adjacent surfaces of plumbing components. Contact time may also allow the composition to treat/coat plumbing surfaces, including surfaces not presently in contact with a clog, to facilitate movement of a clog (or material of a clog that, via treatment, never stops to become a clog in the first place) once a material comes into contact with the plumbing surface. The composition may facilitate movement of the clog, e.g. dislodging or movement further down the piping, either spontaneously or in combination with additional mechanical action such as toilet flushing, addition of water, plunging, etc.

In some examples, the material clog includes or consists of one or more biological materials, one or more fibrous materials, one or more cellulosic materials, or combinations thereof. For example, a clog may be formed with toilet paper (e.g. 1 or 2 ply paper) and feces. In other examples, a clog may include additional materials such as plastic or foam that may be inadvertently or undesirably added to plumbing fixtures in a home (e.g. a toy). In some examples of the method, the method further includes pretreating one or more plumbing component surfaces prior to deposition of the material clog with the one or more release agents. For example, about 10 grams of more of release composition may be added to a toilet bowl as a pretreatment, or about 20 grams or more, or about 50 grams or more, or about 100 grams or more, or about 150 grams or more, or about 200 grams or more.

In certain aspects of the disclosure, methods of pretreatment for one or more plumbing component surfaces prior to deposition of a material clog are disclosed. Example methods may contacting the one or more plumbing component surfaces with any of the compositions described herein, either by direct application, addition to a liquid already in contact with the surfaces such as water, or a combination thereof. As an example, a user may treat toilet water with the composition prior to use, and/or on a regular and/or irregular schedule, such as once a week regardless of whether a clog has formed or not.

The following clauses further illustrate the scope of the disclosure.

1. A composition for releasing a material clog, the composition comprising: one or more release agents; one or more thickening agents; and one or more complexing agents.

2. The composition of clause 1, wherein the one or more release agents comprise at least one silicone material.

3. The composition of clause 2, wherein the silicone material comprises a silicone emulsion.

4. The composition of any of the preceding clauses, wherein the one or more release agents are present in an amount totaling about 25% or less of the composition, by weight, or about 20% or less of the composition, by weight, or about 15% or less of the composition, by weight, or about 10% or less of the composition, by weight, or about 7.5% or less of the composition, by weight, or about 5% or less of the composition, by weight, or about 2.5% or less of the composition, by weight, or about 2% or less of the composition, by weight, or about 1.5% or less of the composition, by weight, or about 1% or less of the composition, by weight, or about 0.5% or less of the composition, by weight, or about 0.25% or less of the composition, by weight.

5. The composition of any of the preceding clauses, wherein the composition further comprises one or more diluents, the one or more diluents present in an amount totaling between about 10-99% of the composition, by weight, or about 5-95% of the composition, by weight, or about 50-99% of the composition, by weight, or about 70-99% of the composition, by weight, or about 80-95% of the composition, by weight, or about 90-99% of the composition, by weight.

6. The composition of any of the preceding clauses, wherein the composition further comprises one or more diluents, the one or more diluents present in an amount totaling at least about 40% of the composition, by weight, or at least about 50% of the composition, by weight, or at least about 55% of the composition, by weight, or at least about 60% of the composition, by weight, or at least about 65% of the composition, by weight, or at least about 70% of the composition, by weight, or at least about 80% of the composition, by weight, or at least about 90% of the composition, by weight, or at least about 95% of the composition, by weight.

7. The composition of any of the preceding clauses, wherein the composition is non-hazardous.

8. The composition of any of the preceding clauses, wherein the composition does not comprise any caustic material, and does not comprise any bleach material.

9. The composition of any of the preceding clauses, wherein the composition further comprises one or more caustic materials, the one or more caustic materials present in an amount totaling about 75% or less of the composition, by weight, or about 50% or less of the composition, by weight, or about 25% or less of the composition, by weight, or about 10% or less of the composition, by weight, 5% or less of the composition, by weight, or about 2% or less of the composition, by weight, or about 1% or less of the composition, by weight, or about 0.5% or less of the composition, by weight, or about 0.2% or less of the composition, by weight, or about 0-5% of the composition, by weight, or about 5-75% of the composition, by weight.

10. The composition of any of the preceding clauses, wherein the composition further comprises one or more bleach materials, the one or more bleach materials present in an amount totaling about 75% or less of the composition, by weight, or about 50% or less of the composition, by weight, or about 25% or less of the composition, by weight, or about 10% or less of the composition, by weight, 5% or less of the composition, by weight, or about 2% or less of the composition, by weight, or about 1% or less of the composition, by weight, or about 0.5% or less of the composition, by weight, or about 0.2% or less of the composition, by weight, or about 0-5% of the composition, by weight, or about 5-75% of the composition, by weight.

11. The composition of any of the preceding clauses, wherein the one or more release agents comprise one or more liquid release agents.

12. The composition of claim 11, wherein the one or more liquid release agents comprise at least one silicone material, at least one mineral oil, at least one plant-based oil, at least one ether material, at least one ester material, at least one polyolefin material, at least one fluorocarbon material, or mixtures thereof.

13. The composition of any of the preceding clauses, wherein the one or more release agents comprise one or more solid release agents.

14. The composition of claim 13, wherein the one or more solid release agents comprise graphite, at least one fluorocarbon material, at least one disulphide material, or mixtures thereof.

15. The composition of any of the preceding clauses, wherein the composition further comprises one or more surfactants, hydrotropes, preservatives, salts, bacterial spore materials, neutralizing materials, or mixtures thereof.

16. The composition of any of the preceding clauses, wherein the composition further comprises one or more enzyme materials, wherein the one or more enzyme materials are capable of acting to breakdown the material clog.

17. The composition of any of the preceding clauses, wherein the composition does not comprise any caustic material.

18. The composition of any of the preceding clauses, wherein the composition does not comprise any bleach material.

19. The composition of any of the preceding clauses, wherein the composition does not comprise any alkaline material.

20. The composition of any of the preceding clauses, wherein the composition is aqueous.

21. The composition of any of the preceding clauses, wherein the one or more release agents comprise one or more polydimethylsilicone materials, one or more alkyl-derivatized silicone materials such as C2-C18 alkyl-derivatized silicones, one or more dimethiconol materials, one or more polyether-modified silicone materials, one or more silicone materials comprising one or more amino groups and/or quaternized ammonium groups, and mixtures thereof.

22. The composition of any of the preceding clauses, wherein the one or more release agents comprise at least one emulsified silicone material.

23. The composition of any of the preceding clauses, wherein the one or more release agents comprise at least one silicone material with a viscosity of about 1-10 million mPas, about 1-5 million mPas, about 0.1-1 million mPas, about 1-3 million mPas, about 1-7 mPas, about 2-5 million mPas, about 2-7 million mPas, about 5-10 million mPas, about 7-10 million mPas, about 7-12 million mPas, or about 10-12 million mPas.

24. The composition of any of the preceding clauses, wherein the one or more thickening agents comprise one or more gum materials such as xanthan gum, one or more polymer materials such as a synthetic polymer material like a acrylate homopolymer and/or a polymer comprising an acrylate copolymer, and derivatives of such polymer materials, one or more acrylic acid-based polymer materials, one or more non-ionic polymer materials, one or more surfactant materials such as an amphoteric, anionic, and non-ionic surfactant material, and one or more swelling or non-swelling clay materials such as a smectite clay material and/or a montmorillonite material.

25. The composition of any of the preceding clauses, wherein the one or more complexing agents comprise a sodium citrate material, one or more phosphate materials, one or more phosphonate materials, one or more citrate materials, one or more iminodisuccinates, glucoheptonate, methylglycine diacetic acid, or one or more salts of EDTA, GLDA, DTPA, HEDTA, EDG, and PDTA.

26. The composition of any of the preceding clauses, wherein the one or more thickening agents are present in an amount totaling about between about 0-20% of the composition, by weight, or about 0-10% of the composition, by weight, or about 0.0.1-10% of the composition, by weight, or about 0.01-5% of the composition, by weight, or about 0.5-5% of the composition, by weight, or about 0.1-5% of the composition, by weight, or about 0.1-3% of the composition, by weight, or about 0.1-1% of the composition, by weight, or about 1-3% of the composition, by weight.

27. The composition of any of the preceding clauses, wherein the one or more complexing agents are present in an amount totaling about between about 0-30% of the composition, by weight, or about 0-20% of the composition, by weight, or about 0.0.1-20% of the composition, by weight, or about 0.01-10% of the composition, by weight, or about 0.5-10% of the composition, by weight, or about 1-7% of the composition, by weight, or about 5-10% of the composition, by weight, or about 1-5% of the composition, by weight, or about 1-25% of the composition, by weight.

28. A non-hazardous composition for releasing a material clog, the composition comprising a release agent comprising a silicone material.

29. A method for releasing a material clog comprising: contacting the clog with one or more release agents comprising a silicone material; and maintaining the contact of the one or more release agents and the clog for a contact period.

30. The method of clause 29, wherein no mechanical action beyond flowing water is used after the contact period to release the clog.

31. The method of clauses 29 or 30, wherein the contact period is 30 minutes or more.

32. The method of any of clauses 29-31, wherein the clog is contacted with any of the compositions of clauses 1-28.

33. The method of any of clauses 29-32, wherein the material clog comprises or consists of one or more biological materials, one or more fibrous materials, one or more cellulosic materials, or combinations thereof.

34. The method of any of clauses 29-33, wherein the clog is contacted with any of the compositions of clauses 1-28 as the method of contacting with one or more release agents.

35. The method of any of clauses 29-34, wherein the method further comprises pretreating one or more plumbing component surfaces prior to deposition of the material clog with the one or more release agents, or a composition of clauses 1-28 including the one or more release agents.

36. A method of pretreating one or more plumbing component surfaces prior to deposition of a material clog, comprising contacting the one or more plumbing component surfaces with the composition of any of clauses 1-28 by direct application, addition to a liquid already in contact with the surfaces such as water, or a combination thereof.

### EXAMPLES

Example compositions 1-10 are provided in Table 1 below to further illustrate the content of this disclosure and/or to provide comparative example performances. All values are provided as weight percent.

TABLE 1

| Component | 1 | 2 | 3 | 4 | 5 | 6 | 7 | 8 | 9 | 10 |
|---|---|---|---|---|---|---|---|---|---|---|
| Water | 94.7 | 78.2 | 58.2 | 12.19 | 96.4 | 97.7 | 98.03 | 99.4 | 97.2 | 91.4 |
| Tomadol 91-6 | 1.5 | 1.5 | 1.5 | 1.5 | — | — | 1.5 | — | — | — |
| Glycol ether DPnB | 3.5 | — | — | — | — | — | — | — | — | — |
| Glycol ether DB | — | 20.0 | — | — | — | — | — | — | — | — |
| Baypure CX 100 | — | — | — | 1.00 | — | — | 1.0 | — | — | — |
| Ammonyx LO | — | — | — | 0.01 | — | — | 0.01 | — | — | — |
| Glycerin | — | — | 40.0 | 40.0 | — | — | 40.0 | — | — | — |
| Caustic Replacement | — | | — | 45.0 | — | — | 45.0 | — | — | — |
| Momentive SM2163 | — | — | — | — | 3.3 | — | 1.67 | 0.3 | 2.5 | 3.3 |
| NPF | | | | | | | | | | |
| PDMS (1000 Silicone) | — | — | — | — | — | 2.0 | — | — | 2.0 | — |
| Sodium Citrate | — | — | — | — | — | — | — | — | — | 5.0 |
| Xanthan Gum FED- | 0.3 | 0.3 | 0.3 | 0.3 | 0.3 | 0.3 | 0.3 | 0.3 | 0.3 | 0.3 |
| CS | | | | | | | | | | |

For the above examples, and equivalent amount of water and composition (200 grams of each) added to a clogged toilet p-trap (clogged using an artificial 50 g bolus made with roughly four parts flour/starch, one part peanut butter, one part cocoa powder, three parts water, and one part egg placed in the bottom curve section), allowed to sit for a contact time of 60 minutes, and then if needed flushed to observe clearance and/or movement if partial dislodgment. If needed, two additional flushes were used to dislodge the clog, each one after 30 minutes (making a total contact time of up to two hours by the third flush). Examples 1 and 2 were able to clear the artificial clog with one or two flushes in example trials, and were able to dislodge the clog over half an inch before any flushing/mechanical action, demonstrating the glycol ether can facilitate release. Example 3 was able to clear the clog upon flushing but never exceed half an inch of movement before flushing, and Example 4 was unable to clear the clog at all, including that alkalinity from the caustic material did not boost release and providing comparative data demonstrating that glycerin is a relatively poor release agent compared to other examples. Examples 5 and 6 dislodged the clogs without flushing during the one-hour contact time, with exact contact times unknown for Example 5 but spontaneous release occurring between 28-36 minutes for trials of Example 6, showing the surprising efficacy and unexpectedly stronger results of using silicone materials rather than other release agent(s). Examples 7-9 further illustrate use of silicone material, where Examples 7 and 9 resulting in dislodgement during the one-hour contact time without any flushing (and for all trials with Example 7), and with Examples 8 and 9 also demonstrating compositions that resulted in dislodged sometime after one flush and before a second. Example 10 is a composition that resulted in clearance after one flush.

In another example, the composition for releasing a material clog includes about 3% of SM2163 NPF as a release agent, about 85% water as a diluent, about 5% sodium citrate as a complexing agent, about 1% Dissolvine GL-47-S as a salt, about 5% of a bacterial material, and less than 1% each of an enzyme material as well as Acticide MBS, Alkonat L 70, and xanthan gum, as a preservative, a surfactant, and a thickening agent, respectively.

These materials, systems and process descriptions are merely examples. In certain embodiments, the compositions include additional components and/or substitutions of some or all of materials described above. In certain embodiments, the processes include additional combinations and/or substitutions of some or all of steps and/or use of the components or conditions described above. Moreover, additional and alternative suitable variations, forms and steps will be recognized by those skilled in the art given the benefit of this disclosure. Finally, any of the features discussed in the example embodiments of the processes and/or systems may be features of embodiments of the compositions, and vice versa.

What is claimed is:

1. A composition for releasing a material clog, the composition comprising:
one or more release agents, wherein the one or more release agents comprise at least one silicone material;
one or more thickening agents;
one or more complexing agents; and
one or more diluents;
wherein the one or more release agents are present in an amount of 25% or less of the composition, by weight;
wherein the one or more diluents are present in an amount totaling between 10-99% of the composition, by weight;
wherein the one or more thickening agents are present in an amount totaling between about 0-20%; and
wherein the one or more complexing agents are present in an amount totaling about between about 0-20% of the composition, by weight.

2. The composition of claim 1, wherein the at least one silicone material comprises a silicone emulsion or at least one emulsified silicone material.

3. The composition of claim 1, wherein the one or more release agents are present in an amount totaling 5% or less of the composition, by weight.

4. The composition of claim 1, wherein the one or more diluents are present in an amount totaling 70-99% of the composition, by weight.

5. The composition of claim 1, wherein the composition is non-hazardous.

6. The composition of claim 1, wherein the composition further comprises one or more caustic materials, the one or more caustic materials present in an amount totaling 1% or less of the composition, by weight.

7. The composition of claim 1, wherein the composition further comprises one or more bleach materials, the one or more bleach materials present in an amount totaling 1% or less of the composition, by weight.

8. The composition of claim 1, wherein the one or more release agents comprise one or more liquid release agents comprising at least one silicone material, at least one mineral oil, at least one plant-based oil, at least one ether material, at least one ester material, at least one polyolefin material, at least one fluorocarbon material, or mixtures thereof.

9. The composition of claim 1, wherein the one or more release agents comprise one or more solid release agents comprising graphite, at least one fluorocarbon material, at least one disulphide material, or mixtures thereof.

10. The composition of claim 1, wherein the composition further comprises one or more surfactants, hydrotropes, preservatives, salts, bacterial spore materials, neutralizing materials, or mixtures thereof.

11. The composition of claim 1, wherein the composition further comprises one or more enzyme materials, wherein the one or more enzyme materials are capable of acting to breakdown the material clog.

12. The composition of claim 1, wherein the composition does not comprise any caustic material, any bleach material, or any alkaline material.

13. The composition of claim 1, wherein the composition is aqueous.

14. The composition of claim 1, wherein the one or more release agents comprise one or more polydimethylsilicone materials, one or more alkyl-derivatized silicone materials such as C2-C18 alkyl-derivatized silicones, one or more dimethiconol materials, one or more polyether-modified silicone materials, one or more silicone materials comprising one or more amino groups and/or quaternized ammonium groups, and mixtures thereof.

15. The composition of claim 1, wherein the one or more release agents comprise at least one silicone material with a viscosity of about 1-10 million mPas.

16. The composition of claim 1, wherein the one or more thickening agents comprise one or more gum materials such as xanthan gum, one or more polymer materials such as a synthetic polymer material like a acrylate homopolymer and/or a polymer comprising an acrylate copolymer, and derivatives of such polymer materials, one or more acrylic acid-based polymer materials, one or more non-ionic polymer materials, one or more surfactant materials such as an amphoteric, anionic, and non-ionic surfactant material, and one or more swelling or non-swelling clay materials such as a smectite clay material and/or a montmorillonite material; and wherein the one or more complexing agents comprise a sodium citrate material, one or more phosphate materials, one or more phosphonate materials, one or more citrate materials, one or more iminodisuccinates, glucoheptonate, methylglycine diacetic acid, or one or more salts of EDTA, GLDA, DTPA, HEDTA, EDG, and PDTA.

17. The composition of claim 1, wherein the one or more thickening agents are present in an amount totaling between 0.1-5% of the composition, by weight, and wherein the one or more complexing agents are present in an amount totaling between 0.5-10% of the composition, by weight.

18. The composition of claim 1, wherein the composition is a liquid material, a gel material, or a solid material.

19. A method for releasing a material clog comprising:
contacting the clog with one or more release agents comprising a silicone material; and
maintaining the contact of the one or more release agents and the clog for a contact period of 15 minutes or more;
wherein no mechanical action beyond flowing water is used after the contact period to release the clog; and
wherein the material clog comprises or consists of one or more biological materials, one or more fibrous materials, one or more cellulosic materials, or combinations thereof.

20. A method of pretreating one or more plumbing component surfaces prior to deposition of a material clog, comprising contacting the one or more plumbing component surfaces with the composition of claim 1 by direct application, addition to a liquid already in contact with the one or more surfaces such as water, or a combination thereof.
